(19) United States
(12) Patent Application Publication
(10) Pub. No.: US 2014/0083833 A1
(43) Pub. Date: Mar. 27, 2014

(54) MINIATURIZED JOYSTICK ASSEMBLY

(71) Applicant: ION AUDIO, LLC, Cumberland, RI (US)

(72) Inventors: Timothy S. Desplaines, Woonsocket, RI (US); Carl K. Barton, Mapleville, RI (US); John E. O'Donnell, Ft. Lauderdale, FL (US)

(73) Assignee: ION AUDIO, LLC, Cumberland, RI (US)

(21) Appl. No.: 13/627,607

(22) Filed: Sep. 26, 2012

(51) Int. Cl. H01H 21/12

(52) U.S. Cl. CPC H01H 21/12
USPC 200/6 A

(57) ABSTRACT

A joystick assembly is disclosed. The assembly includes a retaining plate that has a bore through a central axis. Four microswitches are secured to the retaining plate around the bore. The microswitches each have a switch element facing towards the central axis. A housing is secured to the retaining plate wherein the bore on the retaining plate and the bore on the housing are aligned. A joystick with a shaft is received into the bore on the housing and is configured and arranged to selectively activate the switch elements of the microswitches when deflected.

### BACKGROUND OF THE INVENTION

1. Field of the Invention

The present patent document relates generally to input devices for electronic games and more specifically to a miniaturized joystick that provides an old school fee in a small collapsible package.

2. Background of the Related Art

Portable electronic devices, such as tablet computers, smartphones and music players, increasingly include sophisticated electronics and displays Moreover, with the advent of “app” stores, video games have proven quite popular for these portable devices. Unfortunately, these portable devices lack the control inputs that game players are more accustomed too, often only having a touchscreen interface for input. Although portable shells have been created to augment these touchscreen devices with buttons, most gamers would prefer an old school joystick.

The “D-pad” with carbon contacts is the closest implementation that the prior art has provided for emulating a joystick. However, D-pads lack the old school arcade feel of a joystick, such as audible and tactile clicking that a joystick provides. D-Pads also feel soft and mushy as compared to a joystick, which is undesirable. Prior art joystick assemblies, though, are bulky and impractical to include in a portable shell for a touchscreen device.

Therefore, there is a perceived need in the art for a more compact joystick assembly that can be integrated into smaller portable form factors that also includes the

[symbol]

### SUMMARY OF THE INVENTION

The joystick assembly provides the gamer the old school arcade feel that provides audible and tactile clicking and lacks the mushiness of D-pad type controls. The joystick assembly is also compact and includes a detachable joystick, which enables the assembly to be conveniently included on smaller form-factor devices.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a miniaturized joystick;

FIG. 2 is an exploded view of a miniaturized joystick;

FIG. 3 is a cross-section view through line 3-3 of FIG. 1; and

FIG. 4 is a perspective view of an embodiment of an electronic device implementing the miniaturized joystick.

### DESCRIPTION OF THE PREFERRED EMBODIMENT

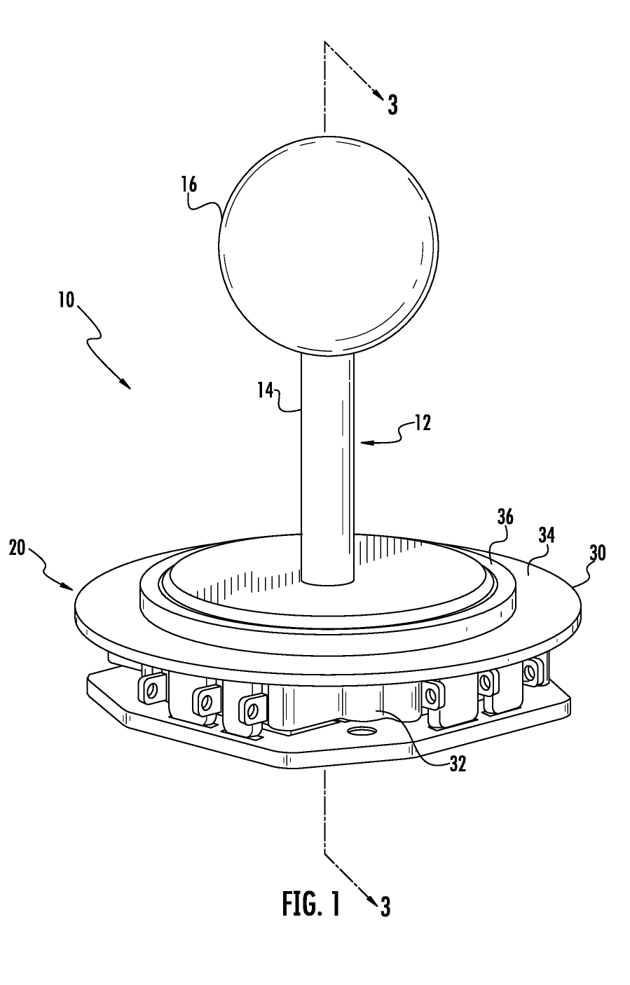

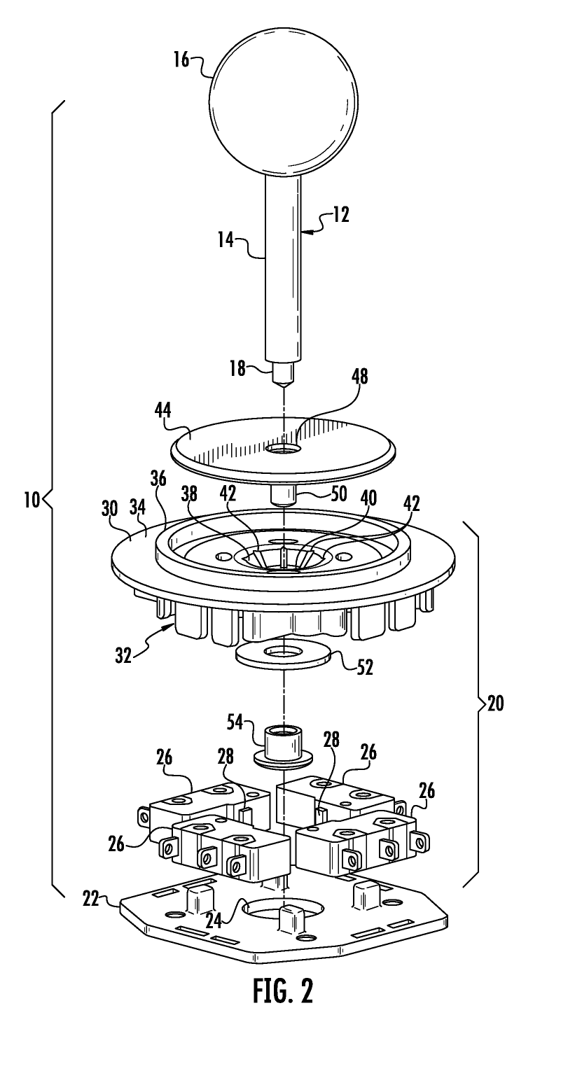

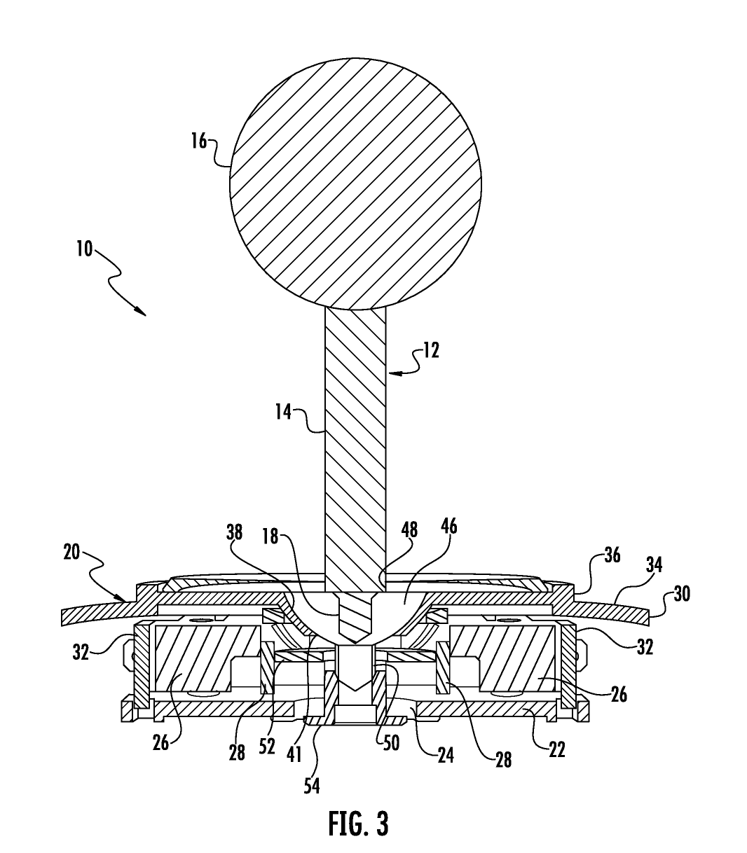

Referring now to FIGS. 1-3, the miniaturized joystick assembly is shown generally at 10. The assembly 10 conspicuously includes, among other part described further below, a joystick 12 having a shaft 14 with a grip 16 secured to the top of the shaft 14. The other end of the shaft includes a smaller-diameter spindle 18 projecting therefrom. The shaft 14 projects upwardly from the housing assembly 20.

The housing assembly 20 includes a retaining plate 22 that includes a bore 24 through a central axis of the retaining plate 22. Four microswitches 26 are secured to the retaining plate 22 around the bore 24 offset ninety degrees from one another. Each microswitch 26 includes a spring-biased switch element 28 that is positioned facing inwardly towards the bore 24.

Secured over the microswitches 26 and retaining plate 22 is an integrated housing and sub chassis 30 of the assembly 10. The sub chassis portion of the housing 30 includes structural elements 32 depending therefrom to reinforce the strength of the assembly 10 and secure the retaining plate 22 thereto.

The housing portion of the housing 30 includes a top surface 34 that includes a peripheral guide 36 extending upwards therefrom. Inward of the peripheral guide is a bowl-shaped depression 38 formed about a bore 40 through the center of the housing 30. When assembled, the bore 40 on the housing 30 aligns with the bore 24 through the retaining plate 22. The bowl-shaped depression 38 includes a number of indentations 42 formed thereon every forty-five degrees around the bore 40, for eight total indentations 42. The indentations 42 provide lubrication wells, which hold grease, for the joystick 12

Received within the peripheral guide 36 of the housing portion is a flexible member 44, made form resilient, flexible material. The flexible member 44 includes a disk-shaped surface of smaller diameter than the peripheral guide 36. A boss 46 depends from the bottom of the flexible member 44. An opening 48 in the top of the flexible member 44 enters the boss 46 with a slot shaped to receive the spindle 18 of the joystick 12. A second shaft 50 depends from the bottom of the boss 46.

A rigid member 52, a washer, is received around the second shaft 50 and a barrel nut 54 is secured to the second shaft 50. When assembled, the rigid member 52 is aligned in contact with the switch elements 28 of the microswitches 26.

Deflecting the joystick 12 towards one of the microswitches 26 causes the shaft 12 to flex the flexible member 44. The boss 46 contacts the interior of the bowl-shaped depression 38 providing tactile feedback of the joystick's 12 position to the user. The second shaft 50 pushes the rigid member 52 against the switch element 28 thereby activating the nearest microswitch 26. If the user deflects the joystick 12 between two microswitches 28, the rigid member 52 will activate the switch elements 28 of both microswitches 28. As is known in the art, with four microswitches 26 positioned at ninety degree intervals, eight effective movement directions can be determined with the joystick assembly 10.

The microswitches 26 are preferably selected provide an audible and tactile click when activated to provide an old-school feel to the joystick assembly 10. Furthermore, the spring-bias of the microswitches 26 and resiliency of the flexible member 44 are selected to be strong enough to re-center the joystick 12 to a neutral position.

For storage and portability, the joystick 12 may be removed from the flexible member 44 by unscrewing it and pulling it free from the assembly 10.

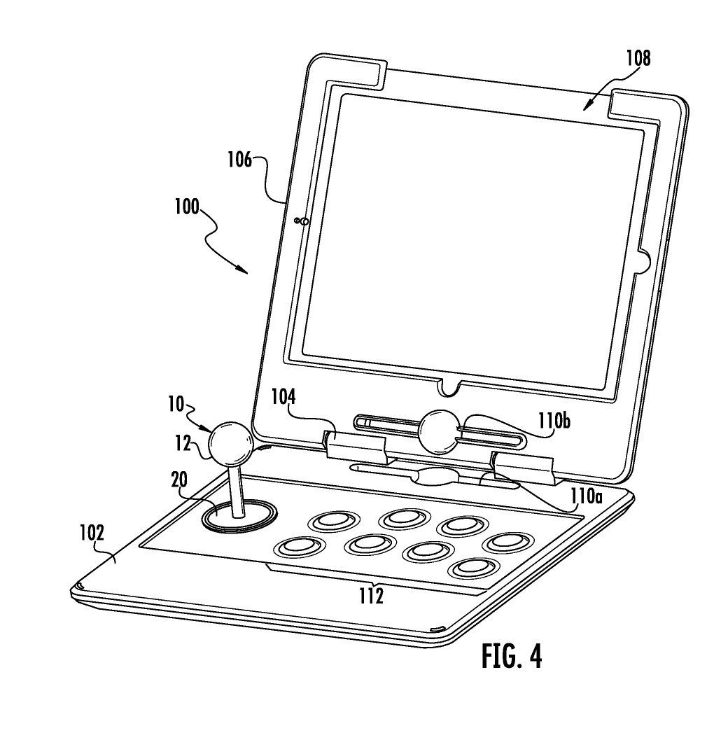

Referring to FIG. 4, the joystick assembly 10 may be included in electronic devices, such as laptop-style cases for tablet computers as shown at 100. The housing assembly 20 is integrated into the lower portion 102 of the laptop-style case 100. A hinge connects 104 an upper portion 106 to the lower portion of the laptop-style case. The hinge 104 has sufficient stiffness to support the upper portion 106 in a desired position. The upper portion 106 of the laptop-style case 100 is configured to receive a tablet computer 108 therein in a landscape or a portrait orientation as desired. The upper portion 106 and lower portion 102 may further include complimentary slots 110a, 110b to receive the joystick 12 when the joystick 12 is disconnected from the housing assembly 20. The laptop-style case 100 may further include a number of buttons 112 to supplement the joystick 12 inputs for playing video games.

The joystick assembly 10 may also be included in other devices that require a low profile joystick, such as laptop computers.

Therefore, it can be seen that the present invention provides a unique solution to the problem for providing a miniaturized joystick that includes an old-school feel retro joysticks that can be used in portable devices.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A joystick assembly, comprising:
a retaining plate having a bore through a central axis;
four microswitches connected to the retaining plate around the bore, the microswitches each having a switch element facing towards the central axis;
a housing connected to the retaining plate wherein the bore on the retaining plate and the bore on the housing are aligned; and
a joystick having a shaft, the shaft connected to the bore on the housing, the joystick further configured and arranged to selectively activate the microswitches when deflected.

2. The joystick assembly of claim 1, wherein the joystick further includes a grip attached to a top of the shaft

3. The joystick assembly of claim 2, wherein the grip is round

4. The joystick assembly of claim 1, further comprising eight indentations spaced axially forty-five degrees apart forming lubrication wells for the joystick.

5. The joystick assembly of claim 1, further comprising at least four indentations spaced axially ninety degrees apart forming at least four lubrication wells for the joystick.

6. The joystick assembly of claim 1, wherein the microswitches are offset axially ninety degrees from one another about the central axis.

7. The joystick assembly of claim 1, wherein the joystick is removable.

8. A joystick assembly, comprising:
a retaining plate having a bore through a central axis;
four microswitches connected to the retaining plate around the bore, the microswitches each having a switch element facing towards the central axis;
a housing connected to the retaining plate wherein the bore on the retaining plate and the bore on the housing are aligned;
a flexible member having a second shaft extending therefrom received through the bore on the housing;
a rigid member connected to the second shaft; and
a joystick connected to the flexible member;
whereby deflecting the joystick causes the flexible member to bend and the rigid member to selectively activate the switch elements of the microswitches.

9. The joystick assembly of claim 8, wherein the joystick further includes a grip attached to a top of the shaft

10. The joystick assembly of claim 9, wherein the grip is round

11. The joystick assembly of claim 8, further comprising eight indentations on the housing spaced axially forty-five degrees apart forming lubrication wells for the joystick.

12. The joystick assembly of claim 8, further comprising at least four indentations on the housing spaced axially ninety degrees apart forming at least four lubrication wells for the joystick.

13. The joystick assembly of claim 8, wherein the microswitches are offset axially ninety degrees from one another about the central axis.

14. The joystick assembly of claim 8, wherein the joystick is removable.

15. A joystick assembly, comprising:
a retaining plate having a bore through a central axis;
four microswitches connected to the retaining plate around the bore, the microswitches each having a switch element facing towards the central axis;
a housing having a top surface with a bowl-shaped depression formed therein, the housing having a bore therethrough, the housing connected to the retaining plate wherein the bore on the retaining plate and the bore on the housing are aligned;
a flexible member having a boss with a second shaft extending therefrom received through the bore on the housing, the pivot further having an opening thereon;
a rigid member received onto the second shaft;
a barrel nut connected to the second shaft; and
a joystick having a shaft with a spindle, the spindle received into opening on the pivot;
whereby deflecting the joystick causes the washer to selectively activate the switch elements of the microswitches.

16. The joystick assembly of claim 15, wherein the bowl-shaped depression further includes a plurality of indentations forming lubrication wells for the joystick.

17. The joystick assembly of claim 16, wherein there are eight indentations spaced axially forty-five degrees apart forming lubrication wells for the joystick.

18. The joystick assembly of claim 16, wherein there are at least four indentations spaced axially ninety degrees apart forming at least four lubrication wells for the joystick.

19. The joystick assembly of claim 15, wherein the microswitches are offset axially ninety degrees from one another about the central axis.

20. The joystick assembly of claim 15, wherein the joystick is removable.
